(19) United States
(12) Patent Application Publication
(10) Pub. No.: US 2008/0203081 A1
(43) Pub. Date: Aug. 28, 2008

(54) VARIABLE THERMAL RESISTOR SYSTEM

(75) Inventors: Steven J. Eickhoff, Brooklyn Park, MN (US); Chunbo Zhange, Plymouth, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/869,228

(22) Filed: Oct. 9, 2007

Related U.S. Application Data
(60) Provisional application No. 60/872,220, filed on Dec. 1, 2006.

(51) Int. Cl. F27D 11/00; B23P 25/00

(52) U.S. Cl. 219/385; 29/458

(57) ABSTRACT

A variable thermal resistance system having a hermetically sealed enclosure around a component. There may be a gap or space between the internal surface of the enclosure and the external surface of the component. A gas, such as a gas from a low vapor pressure solid placed on the internal surface of the enclosure or liquid on a porous internal surface of the enclosure, may fill the space or gap. The gas may have low thermal conduction at low temperatures and high thermal conduction at high temperatures. This may reduce an amount of energy required by a constant temperature maintaining mechanism for the component. At low temperatures less heat is conducted from the component and at high temperatures more heat is conducted from the component so as to reduce the heating and cooling requirements of the temperature maintaining mechanism.

This invention claims the benefit of U.S. Provisional Application No. 60/872,220, filed Dec. 1, 2006. Provisional Application No. 60/872,220, filed Dec. 1, 2006, is hereby incorporated by reference.

### BACKGROUND

The present invention pertains to temperature control of devices and particularly to an apparatus for such temperature control.

### SUMMARY

The invention is a vapor phase variable thermal resistor for efficient thermal control of a device in a changeable ambient temperature environment.

### BRIEF DESCRIPTION OF THE DRAWING

FIGS. 1 and 2 are diagrams of an example arrangement of a shell and device for a vapor phase variable thermal resistor;

FIG. 3 is a graph of thermal conductivity versus gas pressure;

FIG. 4 is a graph of vapor pressure versus temperature;

FIG. 5 is graph of thermal conductivity versus pressure in a log scale for various vapor gaps;

FIG. 6 contains a table showing gyroscope and variable thermal resistor system parameters;

FIG. 7 is a graph showing heat dissipation versus temperature for a variable thermal resistor relative to a package or device;

FIG. 8 contains a table showing parameters of a VCSEL and a variable thermal resistor;

FIG. 9 is a graph of heat loss from a VCSEL versus ambient temperature with the variable thermal resistor system;

FIG. 10 is a graph showing heat dissipation for a previous VCSEL thermal isolation structure and a VCSEL with a vapor phase variable thermal resistor, and the advantage of the latter, versus temperature;

FIG. 11 is a graph of rate output versus temperature for a MEMS gyroscope for evaluating a benefit of the variable thermal resistor used in conjunction with the gyroscope;

FIG. 12 is a graph of compensated bias rate residual versus temperature for the gyroscope;

FIG. 13 is a graph of rate sigma versus tau (time) for the gyroscope; and

FIG. 14 is a graph of rate output versus time for the gyroscope.

### DESCRIPTION

Many systems include components or subsystems that require operation at fixed and elevated temperatures. Temperature regulation is usually achieved by use of a variable power heater that uses more heat when the external environment is cool and uses less heat when the external environment is warm. Often, the power used in this temperature regulation system is a dominant part of the power budget for the entire system. It is desirable to reduce the power required to maintain constant temperature.

The present invention may incorporate a variable thermal resistor that reduces the power required to maintain a device at constant temperature by varying the thermal resistance of the package as a function of temperature. The term “resistor” herein may generally refer to a thermal resistor rather than an electrical resistor.

The present system may be passively adapted to the ambient temperature, without a need of complex mechanical structure. It may be easy to scale from a small to a large device and vice versa without an increase of design and structure complexity. The system may easily adapt to devices of various shapes and surfaces, including irregular ones, and be quite inert to structural failure because of no moving components. The system may enable a temperature-stabilizing capability to an operating temperature range which may have appeared previously not feasible due to power constraints.

Some of the advantages of the system with a VTR compared with a similar system without a VTR may be noted herein. In the present system, there may be significantly lower thermal management power consumption (greater than ten times) than a system without VTR. The present system may significantly extend the operating temperature range (e.g., to a low temperature so as to meet military specs) which appeared previously impossible with other like systems. Thus, this system may make feasible (military) applications of high precision devices at very low temperatures with long-term deployment.

The system may provide a passive approach without a mechanically moving component, and therefore would not necessarily be prone to structural failure and mechanical drift. The system may be non-complex and structurally simple. The system may involve “non-contact”, and be non-intrusive with minimum interference to the subject device function and structure.

Some factors of the present system may include several of the following items. There should be a vapor material selection. It appears desirable to have the vapor material work in the free-molecule and/or transition heat transfer regimes in the desired operating temperatures. The material should be compatible with the process and structure. Although there may be vapor materials available in the temperature range of interest, one might do a parametric study and experimental validation before selection of the material.

In the passive approach of the present system, the thermal performance may be adjusted once built. Thus, one may design and build the device to a set specification without large variation. This may require accurate modeling and some validation during design to eliminate uncertainty.

This approach may require an integration of the functional device, vapor cell, and thermal isolation structure through hermetic packaging. Although hermetic bonding/sealing methods appear well developed, the process compatibility and feasibility may still be examined carefully for accurate design and process control.

Interference from impurities may be a concern. An impurity gas could come from other materials inside the structure, from ambient gas diffusion and/or process-induced gas. It seems virtually impracticable to wholly eliminate all impurities. Thus, it may be important to understand the influence and tolerance of impurity gases and to control them to an acceptable level. Out-gassing from the structure may be controlled by material selection and a getter. The ambient gas intrusion may be controlled by a cautious bonding/sealing design. The process-induced gas may be controlled by a vacuum process.

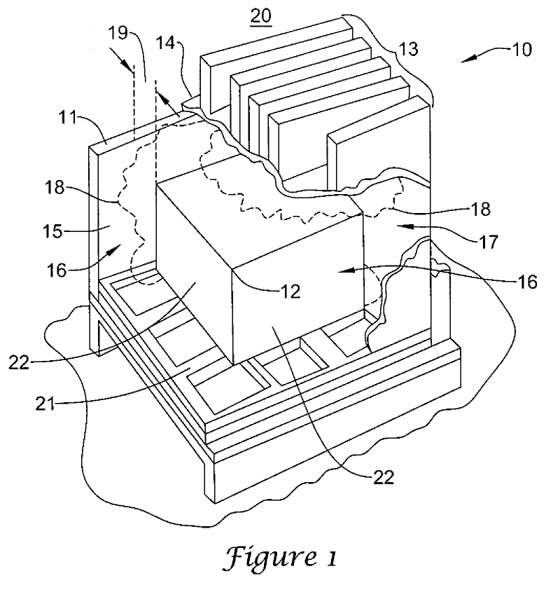

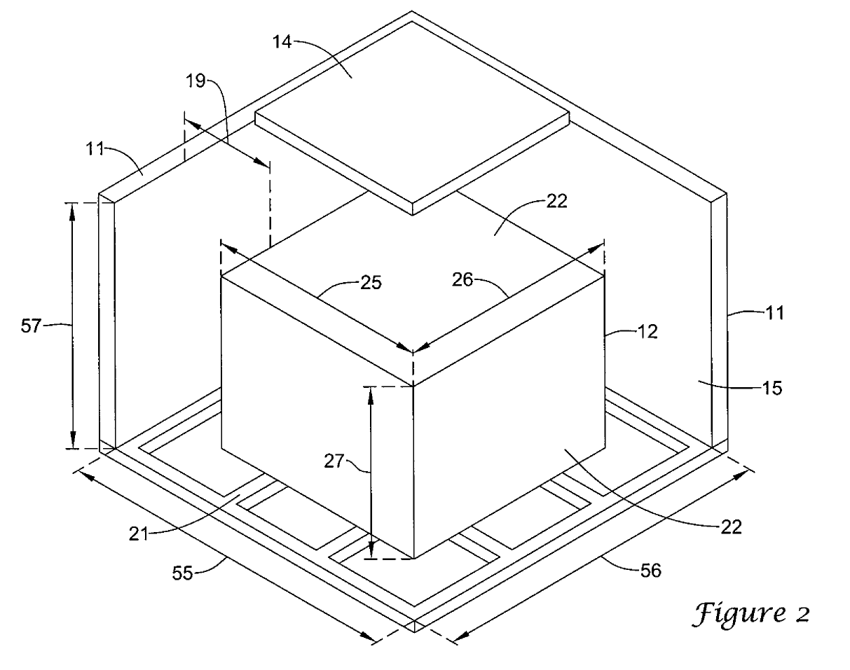

The resistor system 10 may consist of a hermetically sealed solid shell surrounding the device which is to remain at constant temperature (the device being, for example, a VCSEL or a MEMS gyroscope). An instance of an arrangement of the shell or package 11 and device or component 12, is shown cutaway views of FIG. 1 and FIG. 2, with example dimensions indicated in the latter Figure. The exterior of the shell 11 may be exposed to an ambient environment 20 and have a heat exchanger 13 on its outer or external surface 14. An interior surface 15 of the shell or package 11 may be coated with a low vapor pressure solid substance (i.e., vapor generating) 16 (high molecular weight hydrocarbon, naphthalene, anthracine, camphor, or the like) or a low vapor pressure liquid substance (i.e., vapor generating) 16 in a porous structure or matrix of surface 15. Alternatively or additionally, an exterior surface 22 of the device or component 12 may be coated with a low vapor pressure solid substance (i.e., vapor generating) 16 (high molecular weight hydrocarbon, naphthalene, anthracine, camphor, or the like) or a low vapor pressure liquid substance (i.e., vapor generating) 16 in a porous structure or matrix of surface 22.

The space 17 between the shell 11 and the device 12 may be evacuated such that the only gas in the space 17 is the vapor 18 of the low vapor pressure solid 16 or liquid 16. A gap 19 between the shell 11 and the device 12 may be a design parameter of space 17 that can be changed to adjust the heat transfer between the shell 11 and the device 12. The gap 19 may be usually from just above zero to a few millimeters (mm). A structure of low thermal conductance bars or legs 21 may support the device 12 relative to the shell 11 in order to minimize solid conduction losses between device 12 and shell 11. The conductance of the legs 21 may be varied to dissipate the steady state heat generated in the device 12. The surface 22 of the device 12 and low vapor pressure material may be of low emissivity materials to minimize radiation heat losses.

The VCSEL, MEMS gyroscope, or other device 12 may be constant temperature controlled. The device 12 may be encased in a housing having a shape and dimensions similar in proportion to those of the internal surface of the enclosure or shell 11 so as to result in a gap 19 having a constant and/or certain dimension between the surfaces of the shell 11 and device 12. The device with the housing may still be referred as to the device 12.

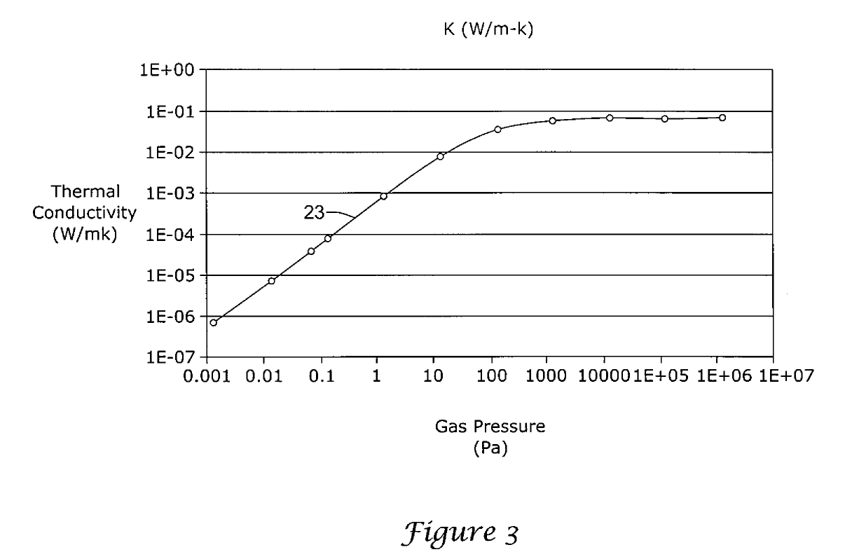

The thermal conductivity of a gas is generally a linear function of pressure from about zero torr to about one torr. In FIG. 3, thermal conductivity (W/mk) versus gas pressure (Pa) is graphed with a curve 23 for naphthalene. In the graph, vapor conductivity appears as a linear function of pressure from a vacuum (Kn>>10) to a transition pressure (0.01<Kn<10) above which it becomes independent of pressure. Many solid materials (for example, high molecular weight hydrocarbons) have vapor pressures in the −50° C. to 70° C. range that fall into a linear region.

At low temperatures, the vapor pressure of the “low vapor pressure material” may be very small, so the thermal conductance of the gap 19 and therefore the heat losses would be very low. At high temperature, the vapor pressure of the “low vapor pressure material” may be higher, so the thermal conductance of the gap 19 and therefore the heat losses would be higher. Thus, the present system may thus be a type of variable thermal resistor 10 that reduces the power required to maintain the VCSEL or other device 12 at a constant temperature under low ambient temperature conditions.

The vapor phase variable thermal resistor (VTR) system 10 may provide a low power approach to significantly improve the performance of the device 12 through temperature stabilization. The VTR 10 may include a hermetically sealed vapor cell or shell 11 and thermal isolation structure surrounding the device or component 12, whose thermal resistance changes by more than ten times over a temperature range of about −40° C. to 85° C. (e.g., a product specification). This passive approach may have no moving parts and take advantage of the non-linear change in vapor pressure with temperature of a vapor generating coating, to modulate the thermal resistance of the gap 19 separating the temperature stabilized component 12 and the VTR package 11.

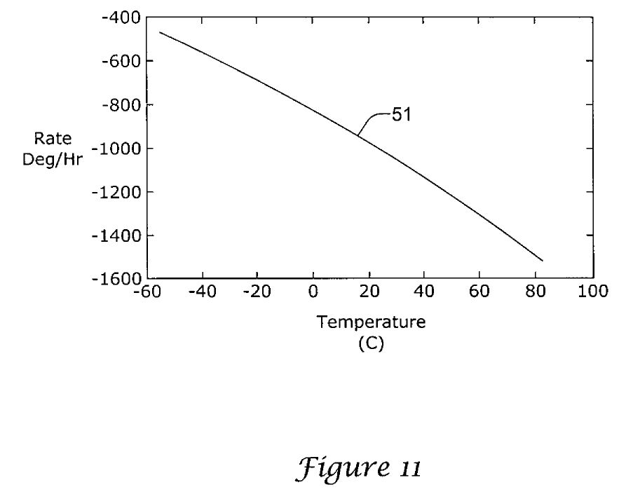

Several applications of the present resistor system 10 and benefits of temperature stabilization with the vapor phase VTR may be noted. One application may include a micro electro mechanical systems (MEMS) gyroscope as a device 12 in which stability improved five times with temperature stabilization (FIGS. 11-14). Another application may include a chip scale atomic clock using a VCSEL in which the power required to temperature-stabilize the VCSEL as the device 12 is reduced by about ten times. The use of the vapor phase VTR system 10 in these diverse applications may illustrate the flexibility of the system to accommodate a wide range of size, geometry, power dissipation, and temperature range requirements. If realized, the vapor phase VTR 10 may significantly reduce the power required by previous thermal management strategies, and enable new levels of performance in applications where temperature stabilization was previously impracticable or virtually impossible due to power constraints.

Many systems may often include components that require operation at a fixed temperature, for example, the vertical cavity semiconductor laser (VCSEL) and physical package of a chip scale atomic clock (CSAC). This may usually be achieved by heating the respective component with a variable power heater which uses more power at low ambient temperatures and less power at high ambient temperatures. In many cases, the power used to regulate component temperature may be a significant portion of the total power budget of the system. Thus, it is desirable to move away from active heating to a thermal management strategy based on a variable thermal resistance and a passive power consumption of the component. At low ambient temperatures the thermal resistance may be high, allowing the component to remain warm without significant heating; while at high ambient temperatures the thermal resistance may be low, allowing the component to dissipate enough heat to maintain the correct temperature. This approach of system 10 may complement maintenance of the temperature of the component 12.

The hermetic package 11 with an externally integrated heat sink 13 may surround the temperature stabilized component 12. A vapor-generating coating 16 (solid or liquid in porous structure) may cover the interior walls 15 of the hermetic package 11. The temperature stabilized component 12 may sit on a low conductance thermal isolation structure 21 attached to package 11, having bars or legs. The pressure in the vapor gap 19 may be modulated by an ambient temperature, which in turn can control the thermal conductance of the gap 19. Due to the non-linear nature of the change in vapor pressure versus temperature, the thermal conductance of the vapor gap 19 may change by five orders of magnitude over a temperature range of −40° C. to 85° C.

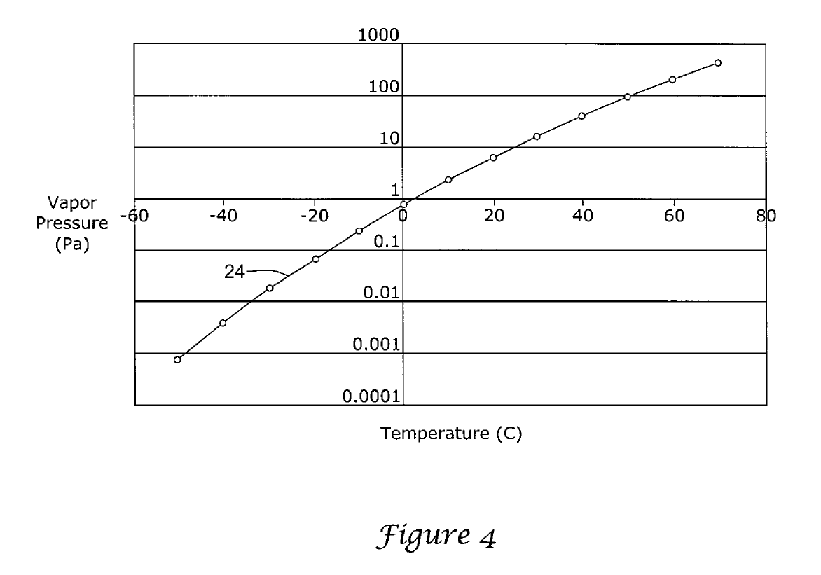

FIG. 4 is a graph of vapor pressure (Pa) versus temperature (° C.) for naphthalene, which may be a material 16 on the walls 15. Vapor pressure appears in the graph as a nonlinear function of temperature according to curve 24 of shell 11. The vapor pressure may change by a factor of 1e4 to 1e6 from −50° C. to 70° C.

The total thermal conductance between the temperature stabilized component 12 and the hermetic package 11 may change by ten times over the temperature range. One may note that the FIG. 2 illustration shows dimensions 25, 26 and 27 related to a VCSEL or device 12. For this illustrative example, dimensions 25, 26 and 27 may be 330, 330 and 280 microns respectively. Device 12 can be a hermetically sealed within package 11 which has internal dimensions 55, 56 and 57, which may be 430, 430 and 380 microns, respectively. The coating on the package 11 inner surface or walls 15 may be low pressure vapor material 16 such as, for instance, a high molecular weight hydrocarbon, e.g., naphthalene. The present system 10 may apply to large range of dimensions and various shapes for various kinds of components 12 where temperature maintenance is desired.

A stabilized component 12 may be maintained at a constant temperature by transferring to the walls of the hermetic package 11 the heat generated inside the component 12 plus the heater power used to sustain (and fine tune) the temperature when needed. Heat dissipation of system 10 may be tunable from 1e1 to 1e5 watt/sq meter by changing the low vapor coating material, gap thickness and surface area. Heat may be transferred by (solid) conduction through the thermal isolation structure 21, (gas) conduction through vapor gap 19, and (either medium) radiation. Heat transfer by free convection in enclosed gaps 19 may be negligible if the product of the dimensionless Grashof and Prandtl numbers is less that one thousand, (Holman, 1990) which is generally the case here. An operating ambient temperature range of the temperature stabilized component 12 may be limited at low ambient temperature by a maximum amount of allowed heater power, and at high ambient temperature by a maximum permissible temperature of the stabilized component 12.

The total heat transfer may be represented by the following equation.

Q_{Tot}=Q_{Solid}+Q_{Gas}+Q_{Rad} (1)

An approximate relationship for the gas thermal conductivity may be represented by the following,

$${K}_{R} = \frac{{K}_{0}}{( 1 + \frac{C}{PP} )} , \qquad ( 2 )$$

where K_{R} is the thermal conductivity at pressure P, K₀ is the thermal conductivity at one-atmosphere pressure, and PP is a pressure parameter,

$$PP = \frac{Pd}{T} \qquad ( 3 )$$

Additional details of the terms in equations (1)-(3), are noted herein.

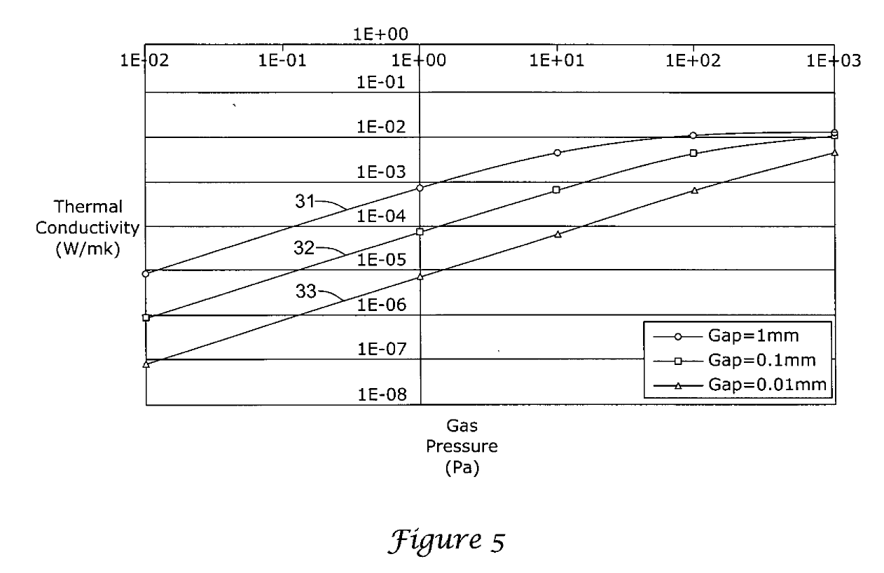

FIG. 5 is graph of thermal conductivity versus pressure in log scales for vapor gaps 19 of 1 mm, 0.1 mm, and 0.01 mm, as shown by curves 31, 32 and 33, respectively, at a temperature of 10° C. The curves in FIG. 5 may result from equation 2 when plotted as a function of gas pressure for various vapor gaps. As the thermal conductivity of the vapor gap increases from 0.01 mm to 1 mm, the thermal conductivity increases by two orders of magnitude for pressures below 100 Pa. The gap distance may thus be one of the key parameters in controlling heat transfer through the vapor gap 19.

It also appears from FIG. 5 that gas pressure has a significant effect on thermal conductivity and, by extension, on heat transfer. If the gas pressure in the gap 19 can be appropriately modulated or controlled as a function of ambient temperature (i.e., low pressure at low ambient temperature and high pressure at high ambient temperature), the heat transferred through the gap 19 may be controlled under certain power constraints.

Gap pressure modulation as a function of temperature may be accomplished passively by coating the interior walls 15 of the package 11 with an appropriate substance 16 (solid, or liquid in porous media). When evacuated, the pressure in the gap 19 may be due only to the vapor pressure of the coating material 16, which can be computed approximately from

$${log}_{10} p = - \frac{0.05223 a}{T} + b , \qquad ( 4 )$$

where “a” and “b” are empirical constants, and “T” is the package 11 temperature. Since the package 11 temperature is essentially equal to ambient temperature, the gap 19 pressure (and thermal conductivity) may be modulated or determined by ambient temperature of environment 20.

A wide range of vapor pressures may be achieved at a given temperature by choosing the appropriate material 16; thus, it may be possible to accommodate a wide range of operating ambient temperatures, heat dissipation levels, and geometries.

A MEMS gyroscope (gyro) is an example of a device 12 in which significant performance improvements are possible with temperature stabilization. With temperature stabilization, the predicted bias stability of the MEMS gyro should improve from 3

$$\frac{deg}{hr} to 0.6 \frac{deg}{hr} ,$$

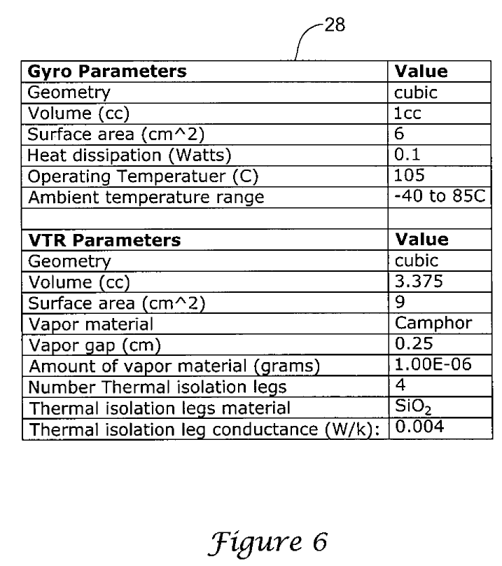

or five times. An application of the vapor phase VTR system 10 to this device may be shown. FIG. 6 contains a table 28 showing gyro and VTR parameters.

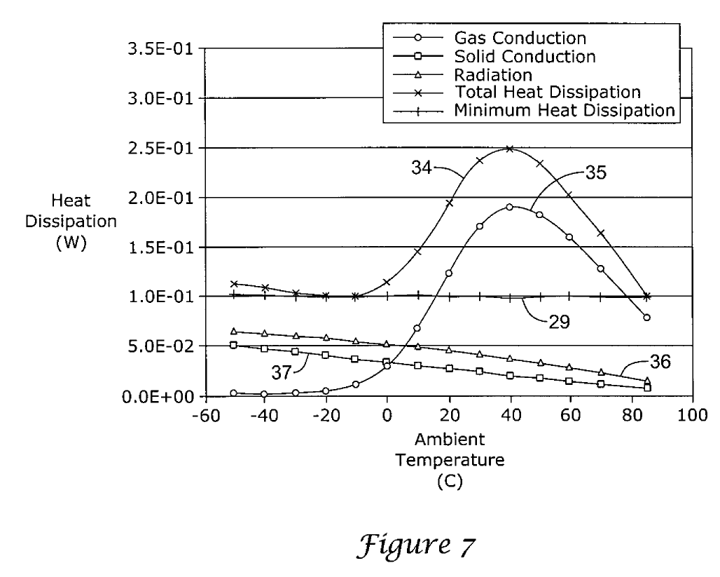

The gyro may consist of a MEMS component and supporting electronics, both of which have temperature sensitive parameters and may benefit from temperature stabilization. The required operating temperature range of the gyro may be said to be from—40° C. to 85° C. The gyro may be approximated as a one cm³ cube that dissipates 100 mW of heat. With these gyro parameters along with VTR parameters, thermal performance of the package may be calculated and plotted. A graph on FIG. 7 shows heat dissipation (i.e., heat loss) versus temperature for the VTR system 10 relative to the package.

From the appearance of the plots in the FIG. 7 graph, the minimum heat dissipation from the gyro is 0.1 watt (star-like line 29), the total heat dissipation for the VTR system 10 is indicated by the top curve (x-like line 34), and the difference between the total heat dissipation (line 34) for the VTR system 10 and the minimum heat dissipation (line 29) for the gyro is generally the heater power required to maintain constant temperature. Curves 35, 36 and 37 represent heat dissipation due to gas conduction, solid conduction and radiation, respectively.

Heater power may be zero when the ambient temperature is 85° C., and may have a maximum of 0.15 watt when the ambient temperature is 40° C. Thus, for a maximum power input of 0.15 watt, the bias stability of the gyro over the ambient −40° C. to 85° C. operating range may improve by five times.

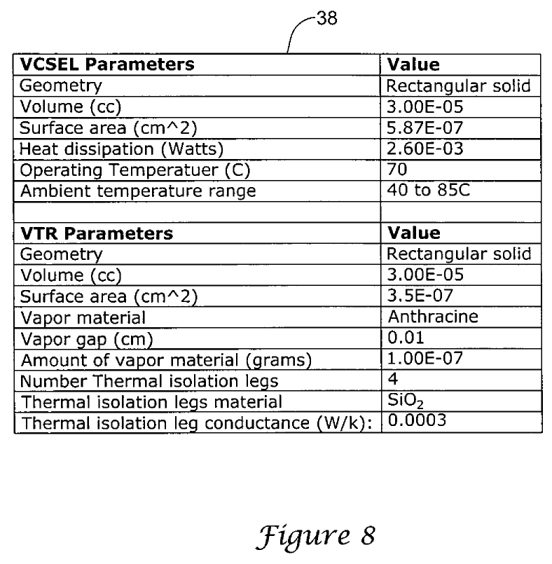

A VCSEL may be used in many applications which require very precise temperature control to maintain constant wavelength. It may be a component 12 of the present system. A table 38 in FIG. 8 shows parameters of a VCSEL and a VTR. In a CSAC, for example, the VCSEL wavelength should be controlled to 0.01 nm, which would require a temperature stability of 0.004° Kelvin. To maintain this temperature stability, the VCSEL may be heated to 70° C. using a combination of the 2.6 mW of power dissipated by the VCSEL and a heater. The heater may use little power when the ambient temperature is high, but it may use as much as 50 mW when ambient temperature is low, which appears to be a significant portion of the total power budget of the CSAC. A prospective reduction in power consumption may be calculated by using a set of parameters descriptively similar to those used for the gyro.

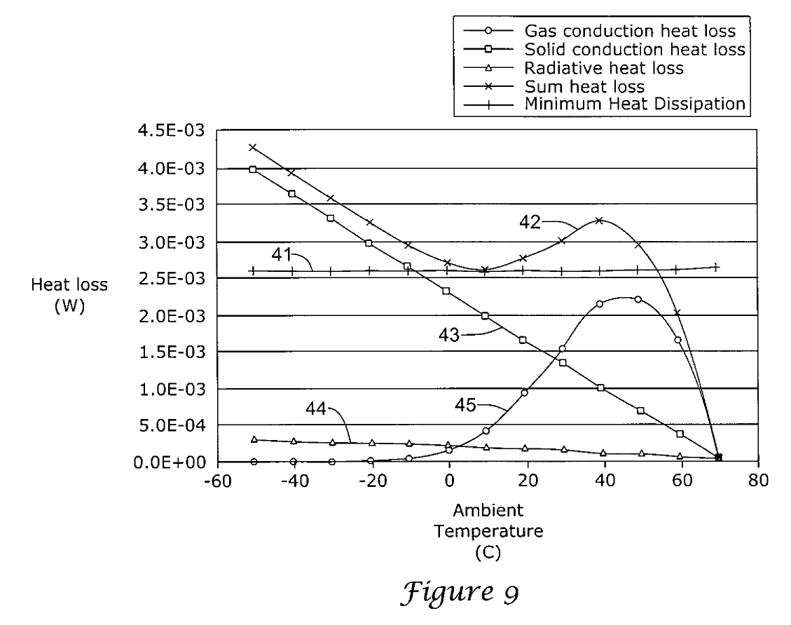

FIG. 9 is a graph of heat loss from the VCSEL versus ambient temperature. The graph shows the solid, gas, radiation, and heat losses for the VCSEL VTR system 10. The minimum heat dissipation for the VCSEL is shown to be 2.6 mW (star-like line 41), the total heat dissipation is shown by the upper “x” curve or line 42, and the heater power is the difference between the total heat dissipation and the minimum heat dissipation. The total heat loss or dissipation (“x” curve 42) may include solid conduction, radiation, and gas conduction through the vapor phase VTR system 10, as represented by curves 43, 44 and 45, respectively. Heater power appears to be about zero at 55° C. (which is the maximum allowable ambient temperature in this design), and the maximum appears to be about 1.7 mW at −50° C. The vapor phase VTR system 10 should be able to operate between −50° C. and 55° C.

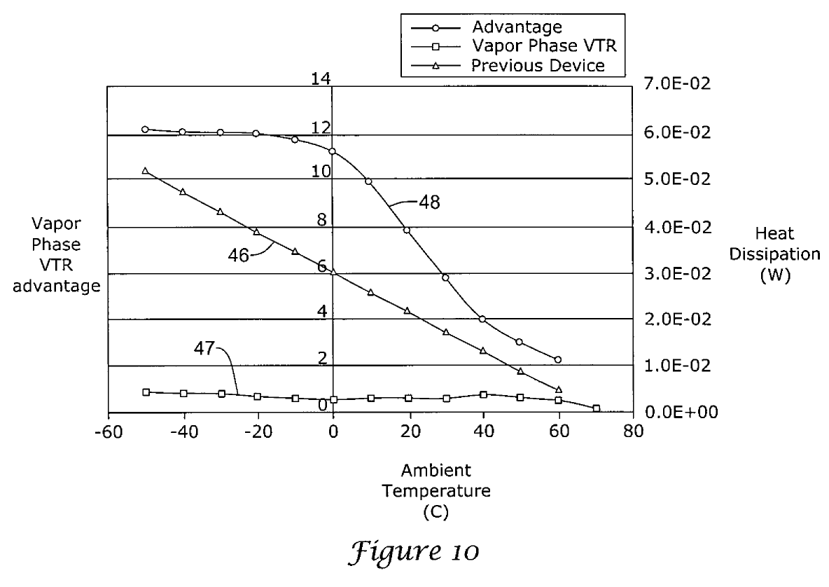

When compared to the heater power requirements of the previous VCSEL thermal isolation structure, the advantage of the VTR appears evident in FIG. 10. At low ambient temperatures (−50° to 20° C.), the VCSEL with VTR 10 may use greater than ten times less power than the previous thermal isolation structure, and greater than two times less power from 20° C. to 60° C. FIG. 10 is a graph showing heat dissipation (W) for a previous VCSEL thermal isolation structure, a VCSEL with a vapor phase VTR 10, and the advantage (of the present system 10 over the previous isolation structure) versus temperature (° C.), as represented by curves 46, 47 and 48, respectively. The previous VCSEL isolation structure is shown to dissipate about 0.45 mW/° C.

Relative to equation (1) herein, the radiation heat transfer for two concentric surfaces may be approximated by the following relationship (Holman 1990),

$${Q}_{rad} = \frac{4 σ {T}^{{*}^{3}}}{\frac{1}{{ɛ}_{1}} + \frac{1}{{ɛ}_{2}} - 1} , \qquad ( 5 )$$

where σ is the Stefan-Bolzmann constant, ε₁ and ε₂ are the emissivities of the surfaces enclosing the gas layer at temperature T*.

The solid conduction Q_{Solid} through the thermal isolation structure may be governed by Fourier's Law,

Q_{Solid=-kA∇T,} (6)

where k is the thermal conductivity of the material, A is the cross sectional area, and ∇T is the temperature gradient. Solid conduction heat transfer may thus be a linear function of the temperature difference between the stabilized component 12 and the package 11.

Heat transfer Q_{Gas} through the vapor gap 19 may be separated into four distinct regimes which are distinguished from each other by the value of the Knudsen number,

$$Kn = \frac{λ}{d} ' \qquad ( 7 )$$

where λ is the mean free path and d is a characteristic length, in this case, the vapor gap 19. In a continuum regime, Kn is less than 0.01, and heat transfer Q_{C} may be calculated using Fourier's Law,

Q_{C}=−kA∇T. (8)

In the temperature jump regime, Kn is between 0.01 and 0.1, and the heat transfer Q_{TJ} may be approximately calculated using an interpolation formula,

$$\frac{1}{{Q}_{TJ}} = \frac{1}{{Q}_{TR}} + \frac{1}{{Q}_{C}} , \qquad ( 9 )$$

where Q_{TR} is the heat transfer in the transition regime.

In the transition regime, Kn is between 0.1 and 10, and the heat transfer may be calculated as (Springer 1971)

$$\frac{{Q}_{TR}}{{Q}_{FM}} = {( 1 + \frac{4}{15} ( \frac{d}{λ} ) {α}_{M} )}^{- 1} , \qquad ( 10 )$$

where α_{M} is the mean value of thermal accommodation coefficients.

In the free molecular regime Kn is greater than 10, and the heat transfer Q_{FM} may be calculated using a relationship developed by Sparrow and Kinney (1964),

$${Q}_{FM} = {( \frac{1}{{α}_{1}} + \frac{1}{{α}_{2}} - 1 )}^{- 1} 2 ρ {R ( \frac{2 π}{{T}^{*}} )}^{- \frac{1}{2}} ( {T}_{S 1} - {T}_{S 2} ) , \qquad ( 11 )$$

where α₁ and α₂are accommodation coefficients, ρ is the gas density, T* is the temperature of a homogenous Maxwellian gas, R is the molar ideal gas constant, and T_{S1} and T_{S2} are the surface temperatures. Another equation may include a number of empirically determined coefficients for the solid and vapor material combination that should be measured to accurately compute the gas heat transfer.

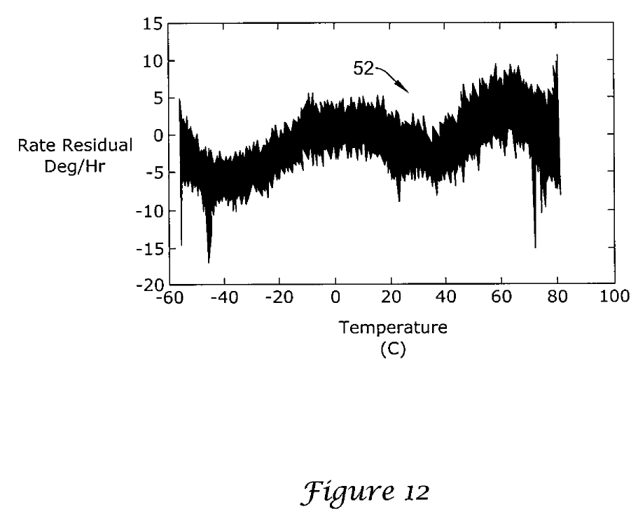

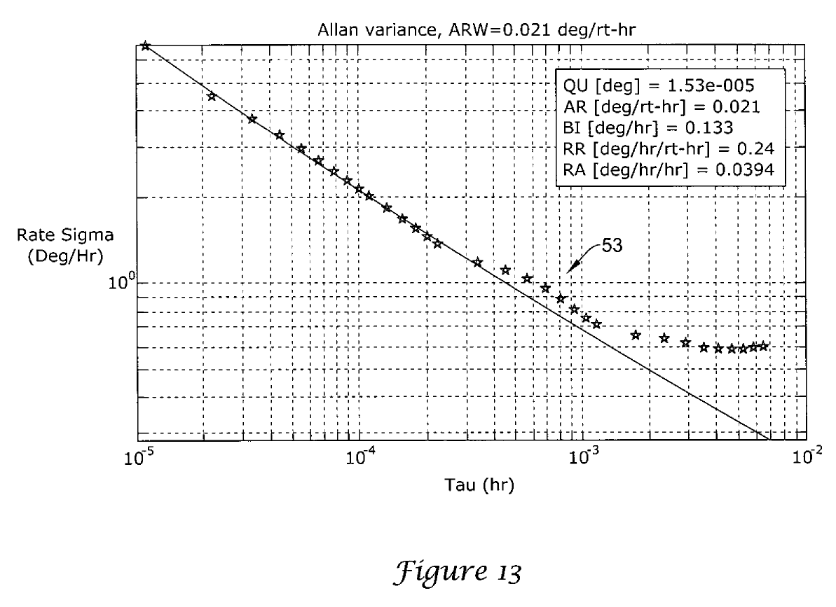

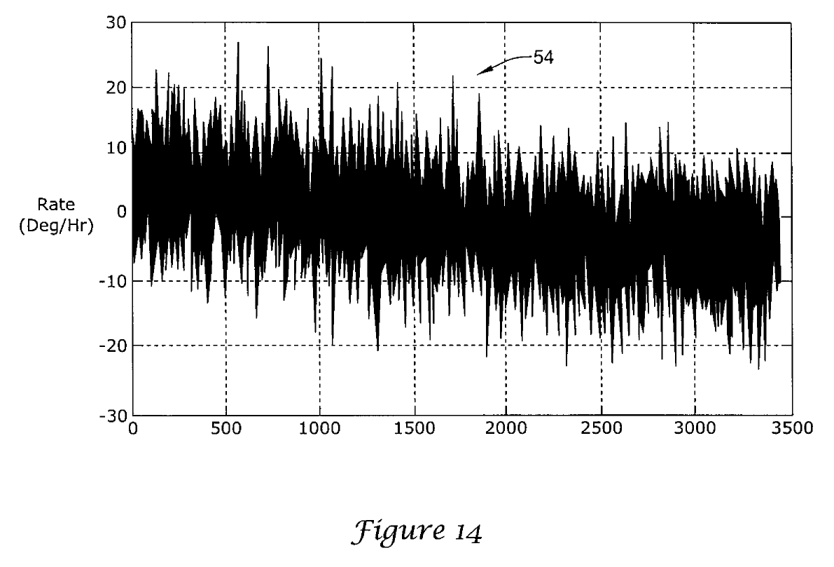

Use of the present vapor phase VTR system 10 may improve the performance of an example MEMS gyroscope (gyro). The gyro may have bias stability over temperature of about 3 deg/hr (1 sigma) as indicated by curve 51 in FIG. 11 which shows a graph of rate output (deg/hr) versus temperature (° C.). The gyro may have a compensated bias stability over temperature of about 3 deg/hr (1 sigma), as may be supported by curve 52 in FIG. 12 which shows a graph of compensated bias rate residual (deg/hr) versus temperature (° C.). The gyro flicker noise floor of the Allan variance may be about 0.6 deg/hr, as may be indicated by data points and line 53 in FIG. 13 which shows a graph of rate sigma (deg/hr) versus tau (hr). The angle random walk (ARW) of the gyro may be a 0.02 deg/rt/hr, as may be supported by curve 54 in FIG. 14 which shows a graph of rate output (deg/hr) versus time. A performance improvement of the gyro due to temperature stabilization (with the present VTR system 10) may include bias stability equaling the flicker noise floor of the Allan variance, which is about 0.6 deg/hr (i.e., an improvement of five times).

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A thermal resistor system comprising:
an enclosure;
a device situated in the enclosure; and
a gas situated in a volume of space between the device and the enclosure.

2. The system of claim 1, wherein the gas comprises a vapor of a low vapor pressure substance.

3. The system of claim 2, wherein the substance is a high molecular weight hydrocarbon.

4. The system of claim 2, wherein the substance is selected from a group consisting of naphthalene, anthracine, camphor, and the like.

5. The system of claim 2, wherein:
the volume has a pressure of the vapor;
the pressure of the vapor is small at low temperatures resulting in small thermal conductance between the device and the enclosure; and
the pressure of the vapor at high temperature is higher than the pressure of the vapor at low temperatures, resulting in a higher thermal conduction.

6. The system of claim 2, wherein:
at a low ambient temperature of the enclosure, the thermal conduction between the device and the enclosure may be low, preventing the device from dissipating heat and permitting the device to remain at an acceptable temperature without significant heating; and
at a high ambient temperature of the enclosure, the thermal conduction between the device and the enclosure may be high, permitting the device to dissipate heat and permitting the device to remain at an acceptable temperature without significant cooling.

7. The system of claim 1, wherein:
the enclosure is hermetically sealed; and
the device is attached to the enclosure with a supporting structure having low thermal conductance.

8. The system of claim 1, further comprising a heat sink attached to an external portion of the enclosure.

9. The system of claim 7, wherein heat is transferred from the device via solid conduction through the supporting structure, gas conduction through the volume, and radiation through the volume.

10. A thermal maintenance system comprising:
an enclosure having an internal surface;
a component situated in the enclosure having an external surface situated at a distance from the internal surface of the enclosure;
a support structure for supporting the component within the disclosure; and
a gas situated in the enclosure.

11. The system of claim 10, wherein the gas has a thermal conductivity that decreases with a reduction of temperature and increases with an increase of temperature.

12. The system of claim 11, wherein:
the component has a mechanism for maintaining the component at a constant temperature;
as a temperature of the enclosure increases, the thermal conductivity of the gas increases thereby conveying heat from the component and minimizing a level of energy required by the mechanism to maintain the component at the constant temperature; and
as the temperature of the enclosure decreases, the thermal conductivity of the gas decreases thereby conveying little heat from the component and minimizing a level of energy required by the mechanism to maintain the component at a constant temperature.

13. The system of claim 11, wherein the distance that the external surface of the component is situated from the internal surface of the enclosure is adjustable.

14. The system of claim 11, wherein a high molecular weight hydrocarbon substance is formed on the internal surface of the enclosure to provide the gas between the internal surface of the enclosure and the external surface of the component.

15. The system of claim 11, wherein a vapor generating liquid substance is in a porous matrix of the external surface of the component to provide the gas between the internal surface of the enclosure and the external surface of the component.

16. A method for providing a variable thermal resistor system comprising:
providing an enclosure having an internal surface and a support structure;
situating a component having a constant temperature maintaining mechanism on the support structure in the enclosure and having an external surface apart from the internal surface of the enclosure resulting in a space between the component and the enclosure;
coating the internal surface of the enclosure with a low vapor pressure substance; and
evacuating the space within the enclosure resulting in a gas in the space which is a vapor of the low vapor pressure substance.

17. The method of claim 16, wherein the low vapor pressure substance is a high molecular weight hydrocarbon.

18. The method of claim 16, wherein the low vapor pressure substance is selected from a group consisting of naphthalene, anthracine, camphor, and the like.

19. The method of claim 16, attaching a heat sink on an external surface of the enclosure.

20. The method of claim 16, wherein:
the gas in the space decreases in thermal conductivity as a temperature of the gas decreases, and increases in thermal conductivity as the temperature of the gas increases;
when the temperature of the gas decreases, less heat is dissipated from the component thereby reducing an amount of energy used by the constant temperature maintaining mechanism to keep the component up to a constant temperature; and
when the temperature of the gas increases, more heat is dissipated from the component thereby reducing an amount of energy used by the constant temperature maintaining mechanism to keep the component down to a constant temperature.
